(19) United States
(12) Patent Application Publication
(10) Pub. No.: US 2026/0141701 A1
(43) Pub. Date: May 21, 2026

(54) MACHINE LEARNING APPARATUS, MACHINE LEARNING METHOD, AND COMPUTER READABLE NON-TRANSITORY RECORDING MEDIUM STORING MACHINE LEARNING PROGRAM

(71) Applicant: JVCKENWOOD Corporation, Yokohama-shi (JP)

(72) Inventor: Shingo KIDA, Yokohama-shi, Kanagawa (JP)

(21) Appl. No.: 19/449,562

(22) Filed: Jan. 15, 2026

Related U.S. Application Data
(63) Continuation of application No. PCT/JP2024/017617, filed on May 13, 2024.

(30) Foreign Application Priority Data
Jul. 19, 2023 (JP) 2023-117326

(51) Int. Cl. G06V 10/778; G06V 10/764; G06V 10/774

(52) U.S. Cl. CPC G06V 10/7792; G06V 10/764; G06V 10/7747

(57) ABSTRACT

A novel class image generation part processes a base class image to generate a novel class image. An image feature amount output part is pre-trained on the base class images, receives the base class image or the novel class image, and outputs an image feature amount. A linguistic classification weight output part is pre-trained on the base class images and sentences describing the base class images, receives a sentence describing the base class image, and outputs a linguistic classification weight. An image classification weight output part receives the image feature amount, calculates an average value of the image feature amount for each class, and outputs the average value as an image classification weight for each class. An optimization part receives the image classification weight and the linguistic classification weight, optimizes the image classification weight, and outputs a reconstructed classification weight.

### CROSS REFERENCE TO RELATED APPLICATION

This application is a continuation of application No. PCT/JP2024/017617, filed on May 13, 2024, and claims the benefit of priority from the prior Japanese Patent Application No. 2023-117326, filed on Jul. 19, 2023, the entire content of which is incorporated herein by reference.

### BACKGROUND

### 1. Technical Field

The present disclosure relates to a machine learning technology.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-learn CNN parameters in response to the entirety of the dataset.

A more efficient and practical method available is incremental learning or continual learning in which new tasks are learned, reusing the knowledge already acquired. In particular, continual learning in a classification task is a method that allows migration from a state in which classification into base classes (classes learned in the past) is enabled to a state in which new classes (novel classes) can be learned for classification.

Meanwhile, there is a phenomenon in deep learning called catastrophic forgetting in which the knowledge acquired in the past is considerably lost, and the ability for tasks is considerably reduced. This presents a problem in continual learning in particular. In continual learning in a classification task, the biggest challenge is to suppress catastrophic forgetting and maintain the performance for base class classification while at the same time acquiring the performance for novel class classification.

On the other hand, new tasks often have only a limited number of sample data items available. Therefore, few-shot learning has been proposed as a method for efficient learning from a small number of training data items. Normally, several thousand samples are necessary for learning. In few-shot learning, however, a task is learned by using a small number of samples (e.g., several samples).

Further, class incremental learning (CIL) has been proposed to additionally train a model already trained on a basic (base) class, thereby enabling classification into a new class (novel class). In CIL, tasks are continually added to a model trained for classification, and novel tasks require classification performance for novel classes and past classes. Normally, training data for novel tasks is big data.

A method called few-shot class incremental learning (FSCIL) has been proposed, which combines continual learning, in which a novel class is learned without catastrophic forgetting of the result of learning the basic (base) class, with few-shot learning, in which a novel class with fewer samples as compared to the base class is learned (Non-patent literature 1). In incremental few-shot learning, the base class can be learned from a large-scale dataset, while the novel class can be learned from a small number of sample data items. FSCIL is an incremental learning scenario for classification similar to CIL but significantly differs in that the number of samples in the training data of the novel class is small (small data).

CEC (continually evolved classifiers) have been proposed as incremental few-shot learning method (Non-patent literature 1). CEC constructs a pseudo-continual learning task and trains a graph attention network (GAT) by using a base class image produced by rotating an original image as a pseudo novel class image.
[Non-patent literature 1] Zhang, C., Song, N., Lin, G., Zheng, Y., Pan, P., & Xu, Y. (2021). Few-shot incremental learning with continually evolved classifiers. In Proceedings of the IEEE/CVF Conference on Computer Vision and Pattern Recognition (pp. 2455-12464).
[Non-patent literature 2] Nishida, K., Nishida, K., & Nishioka, S. (2022). Improving Few-Shot Image Classification Using Machine-and User-Generated Natural Language Descriptions. arXiv preprint arXiv: 2207.03133.
[Non-patent literature 3] Chen, T., Kornblith, S., Norouzi, M., & Hinton, G. (2020, November). A simple framework for contrastive learning of visual representations. In International conference on machine learning (pp. 1597-1607). PMLR.

In the method described in Non-patent literature 1, feature representations for classification of a base class image have already been learned. It may therefore be impossible to train a graph model sufficiently by using an image merely produced by rotating a learned image. Accordingly, there has been a problem in that sufficient classification accuracy cannot be obtained.

### SUMMARY

A machine learning apparatus of the embodiment is a machine learning apparatus that continually learns novel class images fewer than base class images, the machine learning apparatus including: a novel class image generation part that processes the base class image to generate a novel class image; an image feature amount output part that is pre-trained on the base class image and that receives the base class image or the novel class image and outputs an image feature amount; a linguistic classification weight output part that is pre-trained on the base class images and sentences describing the base class images and that receives a sentence describing the base class image and outputs a linguistic classification weight; an image classification weight output part that receives the image feature amount, calculates an average value of the image feature amount for each class, and outputs the average value as an image classification weight for each class; an optimization part that receives the image classification weight and the linguistic classification weight, optimizes the image classification weight, and outputs a reconstructed classification weight; and a classification part that uses the reconstructed classification weight as a weight in classification and outputs a classification by referring to the image feature amount output by the image feature amount output part and to the weight in classification.

Another embodiment relates to a machine learning method. The method is a machine learning method that continually learns novel class images fewer than base class images, the machine learning method including: processing the base class image to generate a novel class image; receiving the base class image or the novel class image and outputting an image feature amount, by using an image feature amount output module that is pre-trained on the base class images; receiving a sentence describing the base class image and outputting a linguistic classification weight, by using a linguistic classification weight output module that is pre-trained on the base class images and sentences describing the base class images; receiving the image feature amount, calculating an average value of the image feature amount for each class, and outputting the average value as an image classification weight for each class; receiving the image classification weight and the linguistic classification weight, optimizing the image classification weight, and outputting a reconstructed classification weight; and using the reconstructed classification weight as a weight in classification and outputting a classification by referring to the image feature amount output by the outputting of an image feature amount and to the weight in classification.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

The disclosure will be described with reference to the following drawings.

FIG. 1 illustrates a related-art CEC method;

FIGS. 2A, 2B are graphs showing the classification accuracy plotted against the rotation angle of the base class image used to train the GAT in related-art CEC;

FIG. 3 shows examples of classification weights input to the GAT in related-art pseudo-continual learning;

FIG. 4 shows examples of classification weights and linguistic classification weights input to the GAT in pseudo-continual learning of the embodiment;

FIG. 5A and FIG. 5B are diagrams comparing the related art and the embodiment in terms of the output of the GAT in pseudo-continual learning;

FIG. 6 is a functional block diagram for illustrating a configuration of the pseudo-continual learning module of the related-art machine learning apparatus that uses CEC;

FIG. 7 is a functional block diagram for illustrating a configuration of the pseudo-continual learning module of the machine learning apparatus of the embodiment that uses CEC; and

FIG. 8 is a functional block diagram for illustrating another configuration of the pseudo-continual learning module of the machine learning apparatus of the embodiment that uses CEC.

### DETAILED DESCRIPTION

The invention will now be described by reference to the preferred embodiments. This does not intend to limit the scope of the present invention, but to exemplify the invention.

CEC is a method to address forgetting of the base class and overfitting to the novel class, which are issues in FSCIL, by separating the feature extractor from the classifier and propagating contextual information between classifiers according to the graph model.

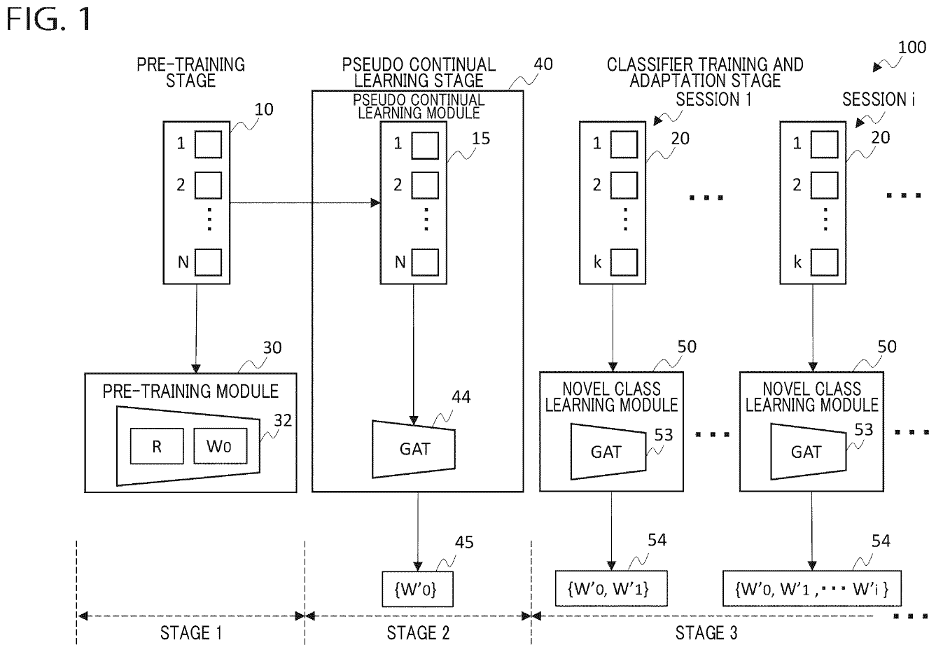

FIG. 1 illustrates a related-art CEC method. As shown in FIG. 1, CEC consists of stages 1-3. The related-art machine learning apparatus 100 includes a pre-training module 30 used in stage 1, a pseudo-continual learning module 40 used in stage 2, and a novel class learning module 50 used in stage 3.

Stage 1 is the pre-training stage. In stage 1, a large amount of base class dataset (hereinafter referred to as basic dataset) 10 is used to pre-train the weights of a backbone CNN 32 of the pre-training module 30 in standard supervised training by the pre-training module 30. The basic dataset 10 includes N data samples. Examples of data samples include, but are not limited to, image data. In the case of the CIFAR100 dataset, for example, the basic dataset 10 includes image data for 60 classes×500 images. The basic dataset 10 may include datasets of a plurality of different classes. The backbone CNN 32 is a convolutional neural network that has been pre-trained on the basic dataset 10. The backbone CNN 32 includes a weight of a feature extractor R and a base class classification weight W0, which is a weight vector of the base class classifier. The base class classification weight W0 indicates the average feature amount of the data sample of the basic dataset 10. By fixing the parameter of the feature extractor R of the pre-trained backbone CNN 32 in subsequent stages, forgetting of the base class is suppressed.

Stage 2 is the pseudo-continual learning stage. In stage 2, the weight of a GAT 44 is trained in the pseudo-continual learning module 40 to propagate the context information of each class and generate a classifier adapted to all classes. Learning in the GAT 44 is performed in an episodic format by constructing a pseudo-continual learning task from a dataset for a rotated image generated by rotating an image of the basic dataset 10. Hereinafter, the dataset generated based on the basic dataset 10 in the pseudo-continual learning stage will be referred to as a pseudo dataset 15.

In stage 2, the base class classification weight is trained based on the feature vector generated by inputting the pseudo dataset 15, which is an alternative dataset of the base class, to the feature extractor R of the backbone CNN 32 pre-trained in stage 1. By inputting the base class classification weight W0 trained in stage 1 and the base class classification weight trained in stage 2 to the GAT 44 of the pseudo-continual learning module, the GAT 44 is caused to adapt and reconstruct these base class classification weights and to output the reconstructed classification weight W′0. Hereinafter, the reconstructed classification weight output from the GAT will be referred to as reconstructed classification weight.

A description will now be given of the episodic format. Each episode consists of a support set and a query set. In the pseudo-continual learning stage, each of the support set and the query set consists of the basic dataset 10 and the pseudo dataset 15. In stage 2, the query samples in both the basic dataset 10 and the pseudo dataset 15 included in the query set are classified based on the support samples of the given support set in each episode, and the parameters of the GAT 44 are updated to minimize the loss in classification.

It should be noted here that the rotated image of the base class is used in the pseudo-continual learning task because the backbone CNN 32 has already learned in stage 1 the feature representation for properly classifying the base class image so that the GAT 44 is not properly trained if the base class image is used as it is. The parameters of the GAT 44 after training are fixed in the subsequent stages.

Stage 3 is the classifier training and adaptation stage. In stage 3, a novel class dataset with a small number of samples (hereinafter referred to as new dataset) 20 given for each session is used in the novel class learning module 50 to train the classifier, and all classifiers trained in the current session and previous sessions are input to a GAT 53 of the novel class learning module 50. Thereby, all classifiers are adapted to the dataset. The GAT 53 of the novel class learning module 50 is the GAT trained in the pseudo-continual learning stage. Query inference is performed by the classifier adapted to the dataset by the GAT 53. The new dataset 20 includes k data samples, which is fewer than the number of samples in the basic dataset 10. The new dataset 20 may include datasets of a plurality of different classes.

In stage 3, a novel class classification weight is trained for each session based on the feature vector generated by inputting the new dataset 20 to the feature extractor R of the backbone CNN 32 pre-trained in stage 1. By inputting the base class classification weight W0 trained in stage 1 and all novel class classification weights {W1, . . . , Wi} trained in each session up to the i-th session in stage 3 to the GAT 53 of the novel class learning module 50, the classification weights of all classes input to the GAT 53 are adapted and reconstructed, and {W′0, W′1, . . . , W′i} reconstructed classification weights 54 are output from the GAT 53.

We focus on pseudo-continual learning in stage 2 of the machine learning apparatus 200 of the embodiment and improve the pseudo-continual learning module 40. The other features remain unchanged from those of the related-art machine learning apparatus 100.

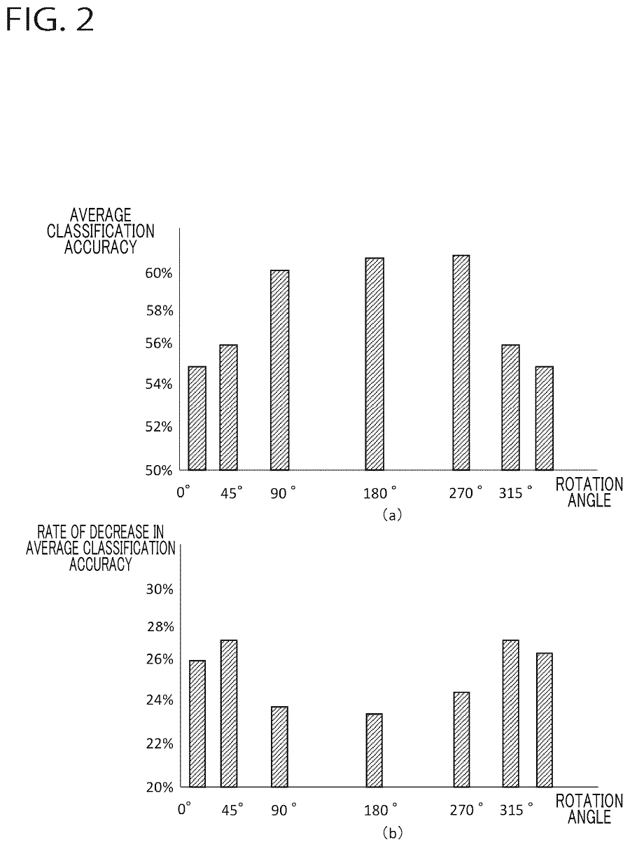

FIGS. 2A, 2B are graphs showing the classification accuracy plotted against the rotation angle of the base class image used to train the GAT in related-art CEC. FIG. 2A shows the average classification accuracy with respect to the rotation angle, and FIG. 2B shows a rate of decrease in the average classification accuracy from the initial session to the final session plotted against the rotation angle. It can be confirmed from FIG. 2A that the classification accuracy is high when the rotation angle is 90°, 180°, or 270°. It can also be seen from FIG. 2B that the rate of decrease in the average classification accuracy from the initial session to the final session is small, and the forgetting of the base class is suppressed when the rotation angle is 90°, 180°, or 270°. Based on this, it is considered to be desirable in pseudo-continual learning to use an image that is visually remote from an image of the base class from the viewpoint of improving classification accuracy.

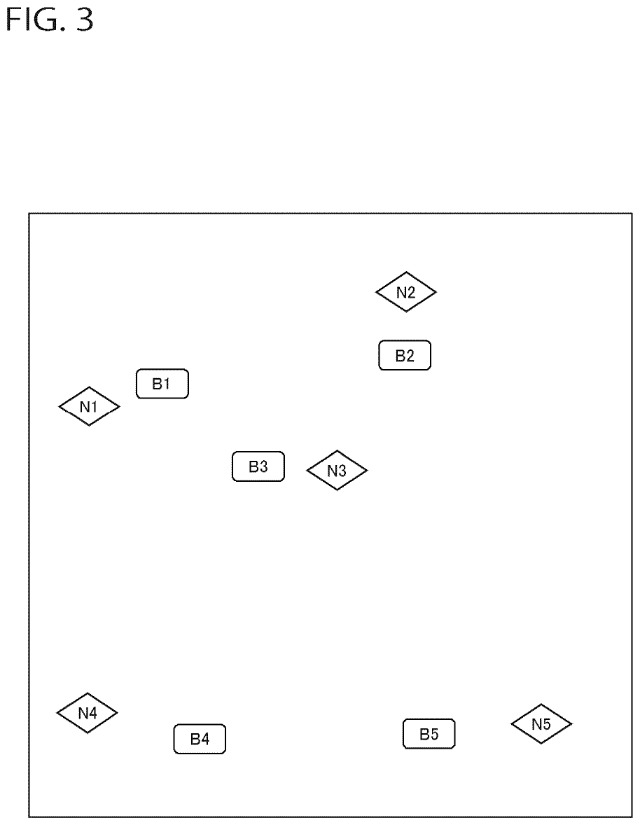

FIG. 3 shows examples of classification weights input to the GAT in related-art pseudo-continual learning. In these examples, the classification weight of each class in the feature space is visualized in a two-dimensional space. The classification weight is also called “prototype”.

The GAT receives inputs of prototypes (B1-B5) of randomly selected five base classes and prototypes (N1-N5) of five novel classes that are generated in a pseudo manner by rotating the images of the base classes. The novel classes N1, N2, N3, N4, and N5 are derived from rotating the base classes B1, B2, B3, B4, and B5, respectively.

As shown in FIG. 3, the prototype derived from averaging the features of base class images and the prototype derived from averaging the features of the rotated base class images do not present a significant visual difference and are located close to each on the feature space so that insufficient GAT training may result. Further, training of GAT parameters is optimized only by cross-entropy loss so that the prototype adjustment may be limited.

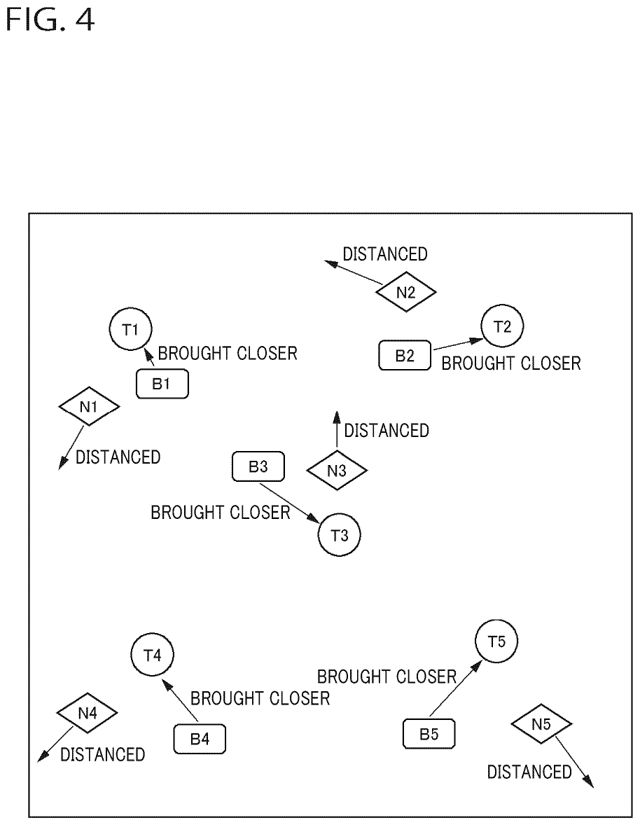

FIG. 4 shows examples of prototypes and linguistic classification weights input to the GAT in pseudo-continual learning of the embodiment. In these examples, the prototype of each class and the linguistic classification weight in the feature space are visualized in a two-dimensional space.

The GAT receives inputs of prototypes (B1-B5) of randomly selected five base classes, prototypes (N1-N5) of five novel classes that are generated in a pseudo manner by rotating the images of the base classes, and linguistic classification weights (T1-T5) of the five base classes (B1-B5). The novel classes N1, N2, N3, N4, and N5 are derived from rotating the base classes B1, B2, B3, B4, and B5, respectively. Linguistic classification weights T1, T2, T3, T4, and T5 are the linguistic classification weights of the base classes B1, B2, B3, B4, and B5, respectively.

In this case, a feature representation, which includes a visual notion representing a base class generated by a trained text encoder model fully trained on big data that pairs images and linguistic representations, is used as the linguistic classification weight, as described in Non-patent literature 2 by way of example. Specifically, the text encoder is used to generate a linguistic classification weight of a base class from a sentence describing the base class image. It will be noted that the linguistic classification weight is referred to as text representation or text feature in Non-patent literature 2.

In addition to cross-entropy loss according to the related-art, GAT parameters are trained by using contrastive loss described in Non-patent literature 3. Specifically, the GAT parameters are trained in pseudo continual learning to bring the prototype of the base class to be closer to the linguistic classification weight including a visual notion representing the base class and to distance the prototype of the novel class from the linguistic classification weight of the base class from which the novel class is rotated.

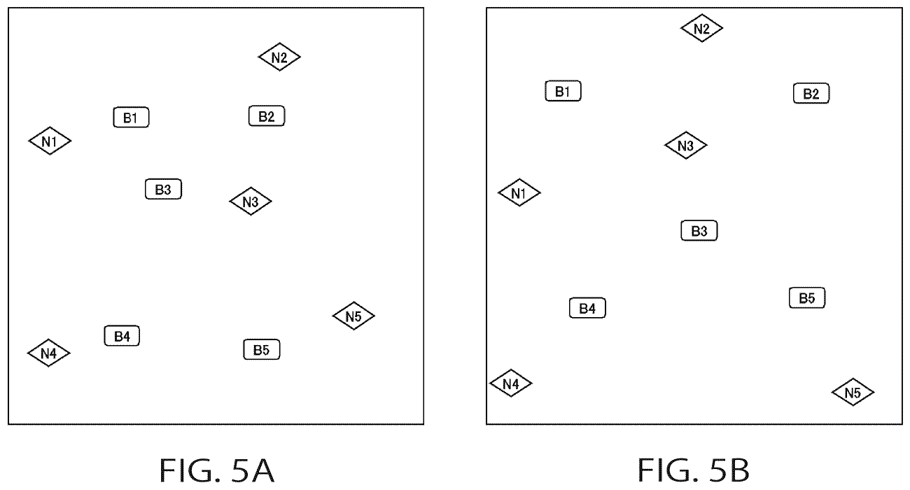

FIG. 5A and FIG. 5B are diagrams comparing the related art and the embodiment in terms of the output of the GAT in pseudo-continual learning. The output of the GAT is a prototype adjusted by pseudo-continual learning.

As shown in FIG. 5A, the related art is characterized by a small amount of movement of the prototype so that the classification accuracy is limited.

In the embodiment, as shown in FIG. 5B, the prototype of the base class after adjustment approaches the linguistic classification weight of the base class, and the prototype of the novel class adjustment is distanced from the linguistic classification weight of the base class from which the novel class is rotated. In this way, the GAT can be effectively trained by optimization using linguistic classification weights so that the amount of movement of the prototype is increased, and the classification accuracy of each class is improved.

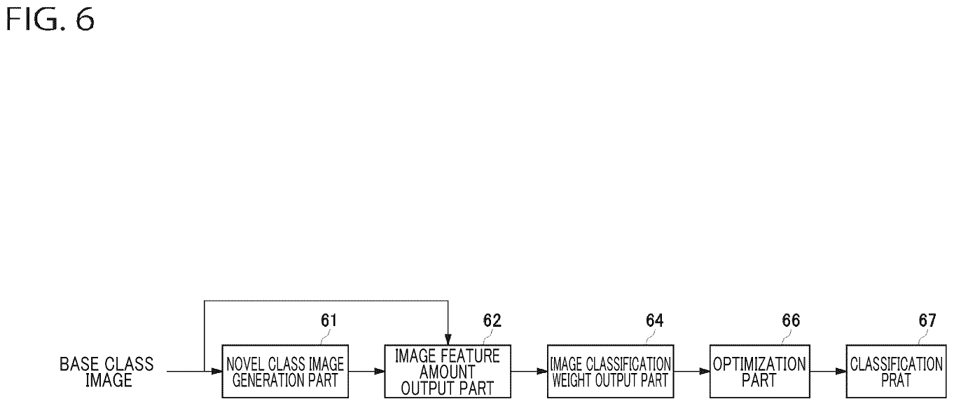

FIG. 6 is a functional block diagram for illustrating a configuration of the pseudo-continual learning module 40 of the related-art machine learning apparatus 100 that uses CEC. The pseudo-continual learning module 40 includes a novel class image generation part 61, an image feature amount output part 62, an image classification weight output part 64, an optimization part 66, and a classification part 67.

The novel class image generation part 61 generates a pseudo dataset 15 for the novel class image by rotating the base class image of the basic dataset 10 used in the pre-training module 30 and supplies the pseudo dataset 15 to the image feature amount output part 62.

The image feature amount output part 62 receives an input of the pseudo dataset 15 of the novel class image, extracts the feature vector of the pseudo dataset 15 of the novel class image, and supplies the extracted image feature amount to the image classification weight output part 64. The image feature amount output part 62 corresponds to the feature extractor R of the backbone CNN 32 pre-trained on the base class classification weight in stage 1.

The image classification weight output part 64 calculates the image classification weight of the pseudo dataset 15 of the novel class image by averaging the feature vectors of the pseudo dataset 15 of the novel class image for each class and supplies the image classification weight to the optimization part 66.

The optimization part 66 corresponds to the GAT 44 and receives the base class classification weight W0 of the backbone CNN 32 pre-trained on the base class classification weight in stage 1 and the base class classification weight of the pseudo dataset 15 supplied from the image classification weight output part 64. The optimization part 66 learns the dependency between the basic dataset 10 and the pseudo dataset 15 by meta learning and outputs the reconstructed classification weight by adapting all input classification weights accordingly. In the pseudo-continual learning module 40, the GAT as a meta-module is trained in an episodic format. Using a query set consisting of the basic dataset 10 and the pseudo dataset 15, the parameters of the optimization part 66 are optimized and updated for each episode. The method described in Non-patent literature 1 to minimize the cross-entropy loss is used as the optimization method in the optimization part 66. The optimization part 66 supplies the reconstructed classification weight thus obtained to the classification part 67.

The classification part 67 uses the reconstructed classification weight as the weight in classification and outputs a classification by referring to the image feature amount output by the image feature amount output part 62 and the weight in classification.

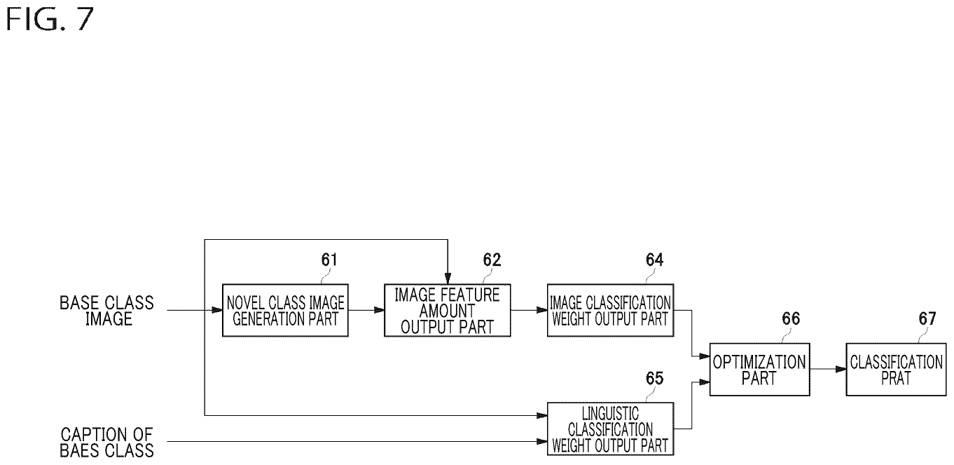

FIG. 7 is a functional block diagram for illustrating a configuration of the pseudo-continual learning module 40 of the machine learning apparatus 200 of the embodiment that uses CEC. The pseudo-continual learning module 40 includes a novel class image generation part 61, an image feature amount output part 62, an image classification weight output part 64, a linguistic classification weight output part 65, an optimization part 66, and a classification part 67. A description of features and operations common to those of the functional blocks of the pseudo-continual learning module 40 of the related-art machine learning apparatus 100 of FIG. 6 is omitted as appropriate, and different features and operations will be described.

The linguistic classification weight output part 65 is pre-trained on base class images and sentences describing the base class images (referred to as “captions”). The linguistic classification weight output part 65 receives the caption of the base class image, generates the linguistic classification weight, which is the linguistic feature amount of the base class image, and supplies the linguistic classification weight to the optimization part 66.

The optimization part 66 receives the image classification weight and the linguistic classification weight, optimizes the image classification weight, calculates the reconstructed classification weight by optimizing the image classification weight, and supplies the reconstructed classification weight to the classification part 67. Specifically, the optimization part 66 calculates the reconstructed classification weight by minimizing the contrastive loss to bring the image classification weight of the base class closer to the linguistic classification weight and distancing the image classification weight of the novel class from the linguistic classification weight.

In the pseudo-continual learning module 40 of the machine learning apparatus 200 of the embodiment, the inter-class distance is increased as compared to the related art by minimizing the contrastive loss with reference to the linguistic classification weight. Accordingly, classification accuracy is improved.

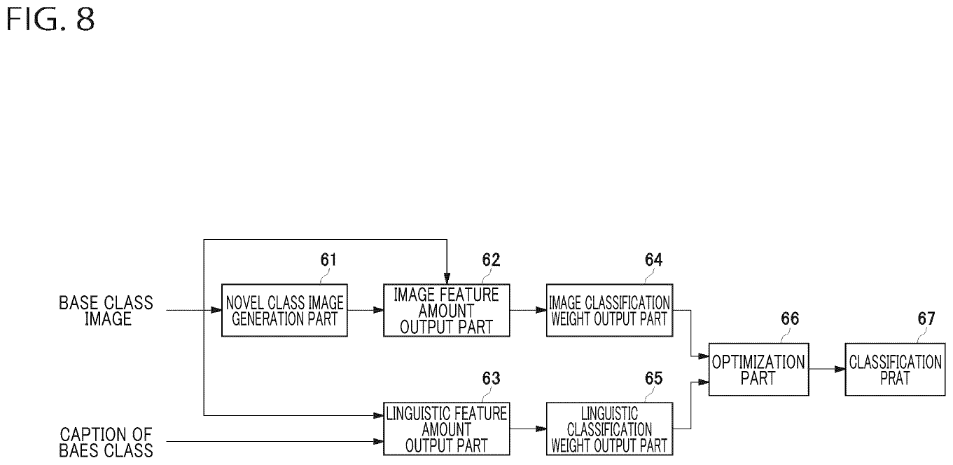

FIG. 8 is a functional block diagram for illustrating another configuration of the pseudo-continual learning module 40 of the machine learning apparatus 200 of the embodiment that uses CEC. The pseudo-continual learning module 40 includes a novel class image generation part 61, an image feature amount output part 62, a linguistic feature amount output part 63, an image classification weight output part 64, a linguistic classification weight output part 65, an optimization part 66, and a classification part 67. The difference from the functional blocks the pseudo-continual learning module 40 of the machine learning apparatus 200 of FIG. 7 is that the linguistic feature amount output part 63 is further provided.

In the case that there are multiple captions for one base class image, the linguistic feature amount output part 63 extracts the linguistic feature amount from each of the multiple captions and supplies the linguistic feature amounts to the linguistic classification weight output part 65. The linguistic classification weight output part 65 calculates the linguistic classification weight by averaging the linguistic feature amounts and supplies the linguistic classification weight to the optimization part 66. The other features and operations are the same as those of FIG. 7.

The above-described various processes in the machine learning apparatus 200 can of course be implemented by apparatuses that use hardware such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiments. The embodiments are intended to be illustrative only and it will be understood by those skilled in the art that various modifications to combinations of constituting elements and processes are possible and that such modifications are also within the scope of the present disclosure.

A method other than the method of rotating the base class image may be used to process the base class image to generate the novel class image. For example, the novel class image may be generated by dividing the base class image into multiple regions and interchanging divided regions.

What is claimed is:

1. A machine learning apparatus that continually learns novel class images fewer than base class images, the machine learning apparatus comprising:
a novel class image generation part that processes the base class image to generate a novel class image;
an image feature amount output part that is pre-trained on the base class image and that receives the base class image or the novel class image and outputs an image feature amount;
a linguistic classification weight output part that is pre-trained on the base class images and sentences describing the base class images and that receives a sentence describing the base class image and outputs a linguistic classification weight;
an image classification weight output part that receives the image feature amount, calculates an average value of the image feature amount for each class, and outputs the average value as an image classification weight for each class;
an optimization part that receives the image classification weight and the linguistic classification weight, optimizes the image classification weight, and outputs a reconstructed classification weight; and
a classification part that uses the reconstructed classification weight as a weight in classification and outputs a classification by referring to the image feature amount output by the image feature amount output part and to the weight in classification.

2. The machine learning apparatus according to claim 1,
wherein the optimization part trains the image classification weight of the base class to be closer to the linguistic classification weight and trains the image classification weight of the novel class to be distanced from the linguistic classification weight.

3. A machine learning method that continually learns novel class images fewer than base class images, the machine learning method comprising:
processing the base class image to generate a novel class image;
receiving the base class image or the novel class image and outputting an image feature amount, by using an image feature amount output module that is pre-trained on the base class images;
receiving a sentence describing the base class image and outputting a linguistic classification weight, by using a linguistic classification weight output module that is pre-trained on the base class images and sentences describing the base class images;
receiving the image feature amount, calculating an average value of the image feature amount for each class, and outputting the average value as an image classification weight for each class;
receiving the image classification weight and the linguistic classification weight, optimizing the image classification weight, and outputting a reconstructed classification weight; and
using the reconstructed classification weight as a weight in classification and outputting a classification by referring to the image feature amount output by the outputting of an image feature amount and to the weight in classification.

4. A computer-readable non-transitory recording medium that stores a machine learning program that continually learns novel class images fewer than base class images, the machine learning program comprising:
a module that processes the base class image to generate a novel class image;
a module that, by using an image feature amount output module that is pre-trained on the base class images, receives the base class image or the novel class image and outputs an image feature amount;
a module that, by using a linguistic classification weight output module that is pre-trained on the base class images and sentences describing the base class images, receives a sentence describing the base class image and outputs a linguistic classification weight;
a module that receives the image feature amount, calculates an average value of the image feature amount for each class, and outputs the average value as an image classification weight for each class;
a module that receives the image classification weight and the linguistic classification weight, optimizes the image classification weight, and outputs a reconstructed classification weight; and
a module that uses the reconstructed classification weight as a weight in classification and outputs a classification by referring to the image feature amount output by the module that outputs an image feature amount and to the weight in classification.
